(19) United States
(12) Patent Application Publication
(10) Pub. No.: US 2017/0187690 A1
(43) Pub. Date: Jun. 29, 2017

(54) Mitigating bot scans of sensitive communications

(71) Applicant: McAfee, Inc., Santa Clara, CA (US)

(72) Inventors: German Lancioni, Cordoba (AR); Igor Muttik, Berkhamsted (GB); Patricio A. Maller, Cordoba (AR); Maria Eugenia Castagnola, Cordoba (AR)

(73) Assignee: McAfee, Inc., Santa Clara, CA (US)

(21) Appl. No.: 14/757,889

(22) Filed: Dec. 24, 2015

(51) Int. Cl. H04L 29/06; H04L 29/08; G06F 17/27; H04L 12/58

(52) U.S. Cl. CPC H04L 63/0428; H04L 51/04; H04L 67/02; H04L 63/1441; G06F 17/2705

(57) ABSTRACT

Particular embodiments described herein provide for an electronic device that can be configured to receive a message, determine that at least a portion of the message includes sensitive data, obfuscate the portion of the message that includes sensitive data, and communicate the message to an electronic device, where the obfuscated portion of the message can be recognized and understood by a recipient associated with the electronic device. In an example, the obfuscated portion of the message can be recognized and understood by a user without the need of special software or hardware but cannot be readily analyzed by a text parsing bot. In some instances, the obfuscation is a human intelligence task element.

### TECHNICAL FIELD

This disclosure relates in general to the field of information security, and more particularly, to mitigating bot scans of sensitive communications.

### BACKGROUND

The field of network communications has become increasingly important in today's society. The Internet has enabled interconnection of different computer networks all over the world. In particular, the Internet provides a medium for exchanging data between different users connected to different computer networks through various types of client devices. While the use of the Internet has transformed business and personal communications, it has also been used as a vehicle for operators to gain unauthorized access to data for intentional or inadvertent disclosure of sensitive information. Current electronic communication methods like email, text messages (SMS) and instant messages, etc. are widely used but do not offer good protection against snooping. The problem is that automated systems such as bots often scan communications and extract data from the electronic communications.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for mitigating bot scans of sensitive communications, in accordance with an embodiment of the present disclosure;

FIG. 2 is a simplified block diagram of a portion of a communication system for mitigating bot scans of sensitive communications, in accordance with an embodiment of the present disclosure;

FIG. 3 is a simplified block diagram of a portion of a communication system for mitigating bot scans of sensitive communications, in accordance with an embodiment of the present disclosure;

FIG. 4 is a simplified flowchart illustrating potential operations that may be associated with the communication system in accordance with an embodiment;

FIG. 5 is a block diagram illustrating an example computing system that is arranged in a point-to-point configuration in accordance with an embodiment;

FIG. 6 is a simplified block diagram associated with an example system on chip (SOC) of the present disclosure; and

FIG. 7 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### EXAMPLE EMBODIMENTS

The following detailed description sets forth example embodiments of apparatuses, methods, and systems relating to a communication system for protected data collection in a multi-node network. Features such as structure(s), function(s), and/or characteristic(s), for example, are described with reference to one embodiment as a matter of convenience; various embodiments may be implemented with any suitable one or more of the described features.

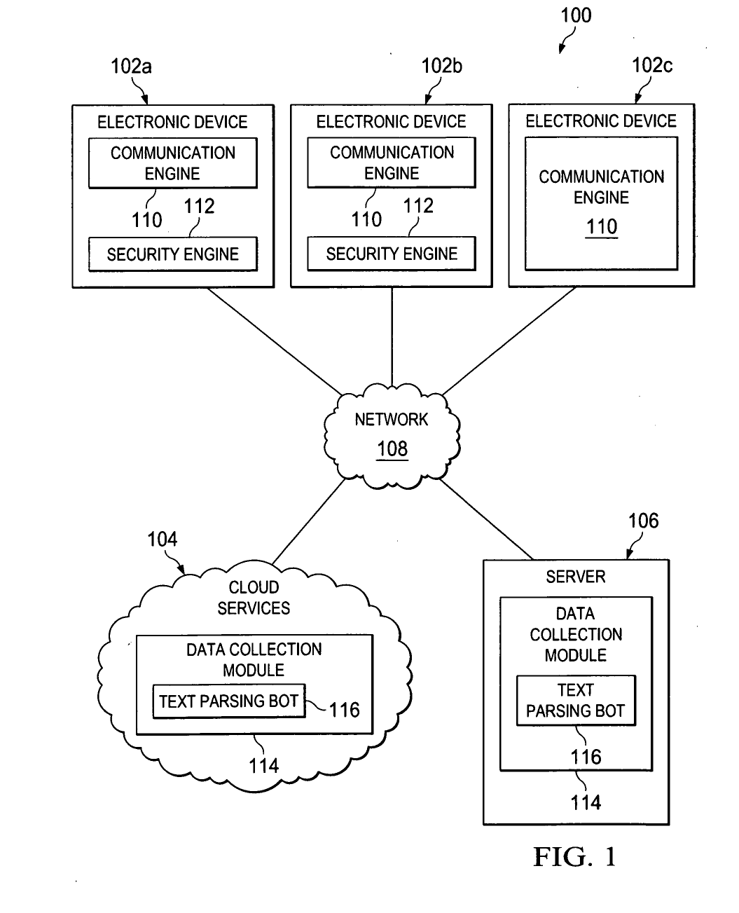

FIG. 1 is a simplified block diagram of a communication system 100 for mitigating bot scans of sensitive communications, in accordance with an embodiment of the present disclosure. Communication system 100 can include one or more electronic devices 102a-102c, cloud services 104, and a server 106. Each electronic device 102a-102c can include a communication engine 110 and a security engine 112. Each of cloud services 104 and server 106 can include a data collection module 114. Each data collection module 114 can include a text parsing bot 116. Electronic devices 102a-102c, cloud services 104, and server 106, can communicate with each other using network 108.

Elements of FIG. 1 may be coupled to one another through one or more interfaces employing any suitable connections (wired or wireless), which provide viable pathways for network (e.g., network 108) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

In an example, communication system 100 can be configured to include a system that allows for mitigating bot scans (e.g., scans by text parsing bot 116) of sensitive communications. Text parsing bot 116 can be an Internet bot', web robot, or simply bot and can be configured to run automated tasks such as text parsing at a much higher rate than would be possible for a human alone. In an example, each of communication engine 110, security engine 112, and data collection module 114 can be any combination of hardware, software, or firmware that is configured to carry out or perform the operations, activities, or functions outlined herein. In an illustrate example, communication engine 110 and security engine 112 can be configured to receive a message, determine at least a portion of the message includes sensitive data, obfuscate the portion of the message that includes sensitive data, and communicate the message to an electronic device, where the obfuscated portion of the message can be recognized and understood by a user. In an example, the obfuscated portion of the message can be recognized and understood by a user without the need of special software or hardware. For example, security engine 112 in electronic device 102a may obfuscate a portion of a message and communication engine 110 can communicate the message to electronic device 102c. The message can be recognized and understood by a user of electronic device 102c even though electronic device 102c does not include security engine 112 or special software or hardware. In some instances, the obfuscation is a human intelligence task element.

For purposes of illustrating certain example techniques of communication system 100, it is important to understand the communications that may be traversing the network environment. The following foundational information may be viewed as a basis from which the present disclosure may be properly explained.

End users have more communications choices than ever before. A number of prominent technological trends are currently afoot (e.g., more computing devices, more connected devices, etc.). One current trend is sending electronic forms of communication.

Current electronic communication methods like email, text messages (SMS) and instant messages, etc. are widely used but do not offer good protection against snooping. The problem is that automated systems such as bots (e.g., text parsing bot 116) often scan communications and extract data from them. Service providers (e.g., email providers, search engines, social sites, etc.) often use bots to scan communications as part of their business model and use the extracted data to support targeted context-based advertising. In some cases, the service providers may even sell the extracted data (raw or aggregated) to other entities. Typically, this context information is extracted from users' messages with automated text/keyword analysis bots on the servers of the service providers.

Encrypting communications (e.g. HTTPS) does not prevent the recipient server (e.g., Whatsapp, Google, Facebook, etc.) from analyzing user-to-user messages because the encryption is stripped on the server side. Social networking sites are usually acting as decrypting proxies, even for private messages, and often do not even attempt to preserve encryption and privacy of the message. A user may explicitly configure the service to avoid analysis (“do not read”) of the user's messages. However, this option is not always offered and there is also no guarantee that the service provider will comply.

Another solution is end-to-end encryption, which is specifically designed to solve the problem of bots and services used to obfuscate the message. However, if a user wants to send sensitive information, then they are required to encrypt or scramble the message (employing cryptography or steganography) and the recipient must use compatible software/service to see the encrypted or scrambled message. The conversions (scramble/unscramble) require both the sender and the recipient to install some software before starting their communications which is not user friendly. This also becomes a much harder problem with more than two users. Additionally, end-to-end encryption requires a set up, typically by exchanging keys, passwords or some other secret. This step is best done via a separate channel. As this is rather awkward, users may use the same channel and exchange secrets in plaintext which allows an attacker (potentially the service provider who wants to snoop user data) to create a man-in-the-middle proxy. What is needed is a system and method that address the problem of protecting privacy of communications from automated analysis by bots.

A communication system for mitigating bot scans of sensitive communications as outlined in FIG. 1, can resolve these issues (and others). In communication system 100, a conventional message can be transformed into an element that is difficult for bots to process. For example, all or part of the message may be transformed into a human intelligence task (HIT) element. The HIT element is difficult for bots to process and can help mitigate bot scans of sensitive communications and enhance user's privacy when using public services such as email, text messages, instant messages, etc. In some examples, one or more parts of a message can be converted into a combination of images, obfuscated text, HyperText Markup Language (HTML), and scripts to produce a difficult to parse (in terms of resources available to bots) message. On the receiving side of the message, the message can render and be easily readable by a user without the need of any additional software, hardware, add-ons, etc. Communication system 100 is not intended to provide a secure communication channel but to increase the cost of attacks/bot analysis on large volumes of messages to the point where it is not economically viable. The system can provide users with a tool to discourage bot scans as a way of increasing the privacy of the data being sent over public (not necessarily encrypted) services.

The transformation from a plain text message to a HIT element can include a JavaScript® (JS) script and images. More specifically, the transformation can be performed by a web extension/browser plugin from a particular application, a virtual keyboard such as a custom virtual keyboard, hot button, macro, etc. In one example, a message entry can be captured (e.g. a text box for the user to type in, copy the text from the clipboard, highlight desired text, etc.). All or a portion of the message can be transformed to a combination of elements such as HTML elements, obfuscated text, scripts and embedded captcha'ed style images. The generated layout of the transformed message can be embedded (HTML content) into the body of the message (e.g., email or text message body). HTML allows for images and objects to be embedded in the message which makes the data difficult for bots to recognize but a user can easily recognize the data.

Communication system 100 can be configured to mitigate bot scans of sensitive or private content that the user wants to protect from different network bots. It should be noted that the objective of at least some of the disclosed embodiments is not to protect the content from other humans (like encryption systems would do), but from automatic bots (although advanced bots would be able to parse the content, the amount of computational resources, including time, to execute this over a high volume of messages would be considerable/prohibitive). Communication system 100 can be integrated with applications or services that do not implement a robust privacy preservation model and allow for the opportunity to add an extra privacy layer to harden the applications or services that are not implementing the robust privacy preservation model. For example, instead of sending an email as plain text over a communication service that is reading the content of the user, the user can send a HIT based email through the service so bots would not be able to easily parse the message content. For the recipient of the message, the system does not require a third party product or cloud service to read the message (compared to encryption software or services which must be used by the recipient as well). In addition, the system does not require attaching a file to the message since the HIT element would typically be embedded into the message body as a combination of HTML elements, scripts, and images.

The system can increase the HIT complexity if/when it is detected that bots become successful in retrieving the content from obfuscated messages. This can be done automatically (e.g. via updating the rules or code which generate HIT elements) to keep bot operation permanently economically non-viable. The system does not require a key or shared secret with the recipient and the message is still readable by users, but not easily readable by bots. Implementation can be done in many ways such as a browser plugin, a dedicated application, or a custom keyboard. The system can also improve privacy for users, regardless of the communication protocol used (as long as the service supports embedding images/html/scripts into messages). For example, users may no longer see ads related to their email content. In addition, the system can work well with multiple recipients and is suitable as a simple method to exchange secrets in preparation for end-to-end (multi-) user communications. Also, when a user's message contains an image (or a video) it may also be HIT-converted (e.g. sliced into parts) to complicate/prevent image analysis, snooping or storage by the service provider.

Turning to the infrastructure of FIG. 1, communication system 100 in accordance with an example embodiment is shown. Generally, communication system 100 can be implemented in any type or topology of networks. Network 108 represent a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals (analog, digital or any combination of the two), data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications (e.g., over a cellular network) may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic devices 102a-102c, cloud services 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic devices 102a-102c, cloud services 104, and server 106 can include memory elements for storing information to be used in the operations outlined herein. Each of electronic devices 102a-102c, cloud services 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), non-volatile memory (NVRAM), magnetic storage, magneto-optical storage, flash storage (SSD), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic devices 102a-102c, cloud services 104, and server 106 may include software modules (e.g., device data collection engine 110, network data collection engine 114, etc.) to achieve, or to foster, operations as outlined herein. These modules may be suitably combined in any appropriate manner, which may be based on particular configuration and/or provisioning needs. In some embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic devices 102a-102c, cloud services 104, and server 106 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Each of electronic devices 102a-102c can be a network element and includes, for example, desktop computers, laptop computers, mobile devices, personal digital assistants, smartphones, tablets, wearables, or other similar devices. Cloud services 104 is configured to provide cloud services to electronic devices 102a-102c. Cloud services may generally be defined as the use of computing resources that are delivered as a service over a network, such as the Internet. The services may be distributed and separated to provide required support for electronic devices 102a-102c and cloud services 104. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication system 100. Although data collection module 114 is represented in FIG. 1 as being located in cloud services 104 and server 106, this is for illustrative purposes only. Data collection module 114 could be combined or separated in any suitable configuration.

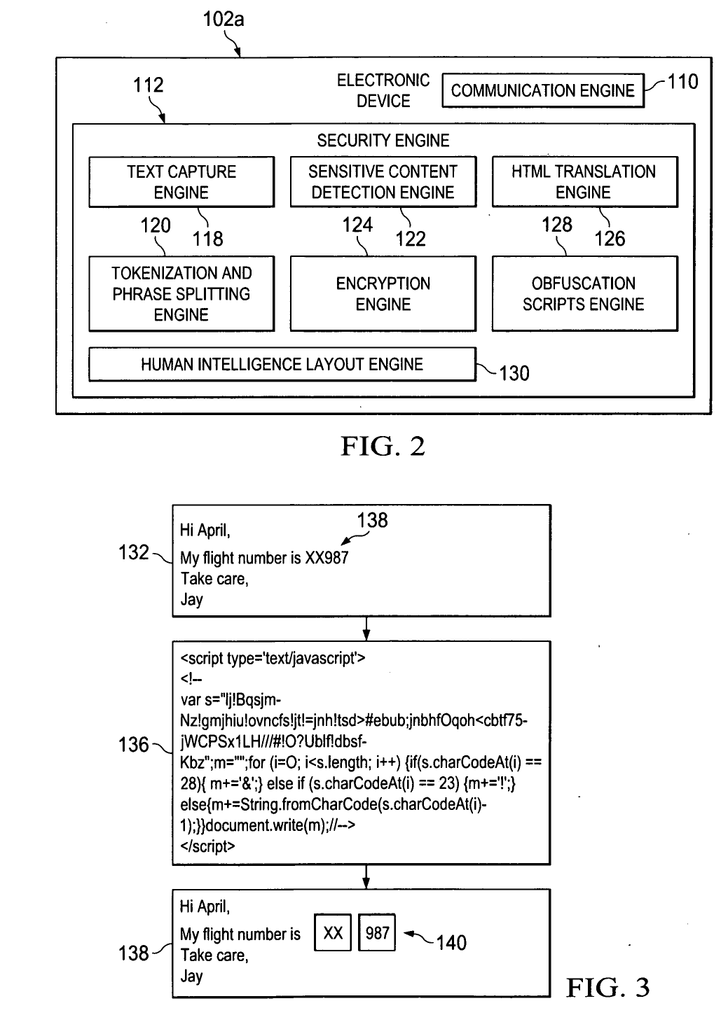

Turning to FIG. 2, FIG. 2 is a simplified block diagram of a portion of communication system 100 for protected data collection in a multi-node network in accordance with an embodiment of the present disclosure. As illustrated in FIG. 2, electronic device 102a can include communication engine 110 and security engine 112. Security engine 112 can include a text capture engine 118, a tokenization and phrase splitting engine 120, a sensitive content detection engine 122, an encryption engine 124, HTML a translation engine 126, an obfuscation scripts engine 128, and a human intelligence layout engine 130. In an example, one or more of text capture engine 118, tokenization and phrase splitting engine 120, sensitive content detection engine 122, encryption engine 124, HTML translation engine 126, obfuscation scripts engine 128, and human intelligence layout engine 130 can be located in communication engine 110 or in another location of electronic device 102a.

Text capture engine 118 can be configured to intercept or capture the text, images, videos, or other user content being written or input by a user. Text capture engine 118 can offering a special text box for input, providing a highlight selection capability in the browser, copying from the clipboard, or some other means for capturing text or content entered by the user. In an example, in order to transform the plain text to the HIT layout, text capture engine 118 needs to be activated when a user is composing the message. Text capture engine 118 can be activated as a browser plugin in a desktop or a custom keyboard in a mobile device.

Tokenization and phrase splitting engine 120 can be configured to process the text or content entered by the user for formatting. The formatting may include tokenization of the words and sentence splitting to analyze and accommodate the message content. The result of this process can be a structured message format, which is used to generate a HIT layout. Sensitive content detection engine 122 can be configured to analyze the structured message to detect sensitive data and text such as passwords, social security numbers, home address, birthday date, credit card number, flight number, etc. Encryption engine 124 can encrypt the sensitive data detected by sensitive content detection engine 122 and convert the words from text to images representing the same text content. These images can be sent to HTML translation engine 126.

HTML translation engine 126 can be configured to transform the plain text into a HTML layout including HTML elements (e.g. spans, embedded images, etc.). Obfuscation scripts engine 128 can be configured to obfuscate the resulting layout in such a way that embedded scripts will be able to reverse the process when the HIT layout is rendered and the message is presented to the recipient of the message (e.g., when reading the email or text message). Human intelligence layout engine 130 can be configured to embedded the HIT layout into the original message (e.g., via the clipboard, in a file, via directly modifying the message body, etc.). The messages is then communicated to the recipient. Bots cannot analyze the embedded HIT layout (containing HTML elements, obfuscated scripts and embedded images representing portions of the text) which results in a better privacy experience with the text service. At the same time, the user experience is not significantly impacted and the recipient will be able to read the message as usual but the message cannot be readily analyzed by a text parsing bot.

Turning to FIG. 3, FIG. 3 is a simplified block diagram of a portion of communication system 100 for mitigating bot scans of sensitive communications, in accordance with an embodiment of the present disclosure. As illustrated in FIG. 3, a text message 132 includes sensitive data 138. In this example, the sensitive data is a flight number but the sensitive data could be any data such as passwords, birthday date, credit card number, etc. The text in text message 132 may have been entered by a user using text capture engine 118. Sensitive content detection engine 122 can recognize sensitive data 138. Encryption engine 124 can pass text message 132 to HTML translation engine 126 where text message 132 can be converted to HTML 136. Obfuscation scripts engine 128 and HIT layout engine 130 can convert sensitive data 138 to obfuscated data 140 (e.g., HIT layout) and embed obfuscated data 140 into the converted HTML message to create obfuscated message 138. Obfuscated message 138 with obfuscated data 140 can be communicated to a recipient where the recipient can read and recognize the message without having to install special software or applications but bots cannot easily analyze obfuscated data 140. For example, a user associated with electronic device 102a may compose a text message that includes sensitive data. Security engine 112 can obfuscate the sensitive data and the message with the obfuscated sensitive data can be communicated to electronic device 102c where it can be read by a user associated with electronic device 102c, even though electronic device 102c does not include security engine 112 or specialized software such as that required by encryption service.

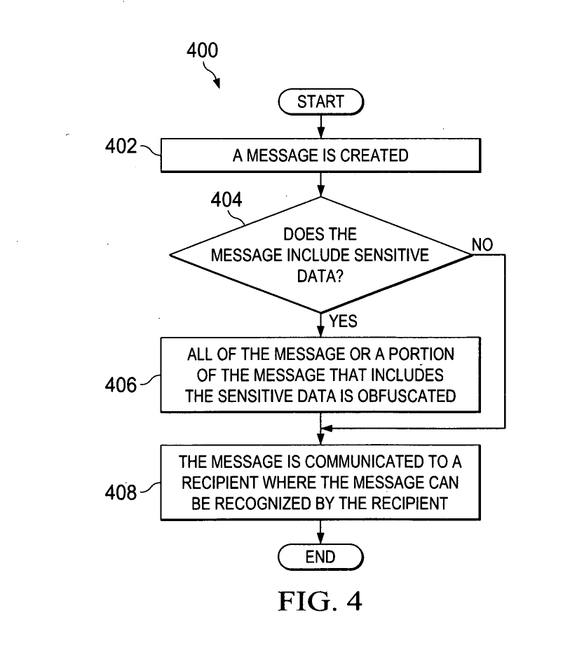

Turning to FIG. 4, FIG. 4 is an example flowchart illustrating possible operations of a flow 400 that may be associated with mitigating bots scans of sensitive communications, in accordance with an embodiment. In an embodiment, one or more operations of flow 400 may be performed by one or more of communication engine 110, security engine 112, text capture engine 118, tokenization and phrase splitting engine 120, sensitive content detection engine 122, encryption engine 124, HTML translation engine 126, obfuscation scripts engine 128, and human intelligence layout engine 130. At 402, a message is created. At 404, the system determines if the message includes sensitive data. If the message does not include sensitive data, then the message is communicated to a recipient where the message can be recognized or read by the receipted, as in 408. If the message does include sensitive data, then all of the message or a portion of the message that includes the sensitive data is obfuscated, as in 406. For example, the portion of the message that includes the sensitive data may be converted to a HIT element. At 408, the message is communicated to a recipient where the message can be recognized or read by the receipted. The recipient can read or recognize the message without the need of special software, applications, hardware, etc.

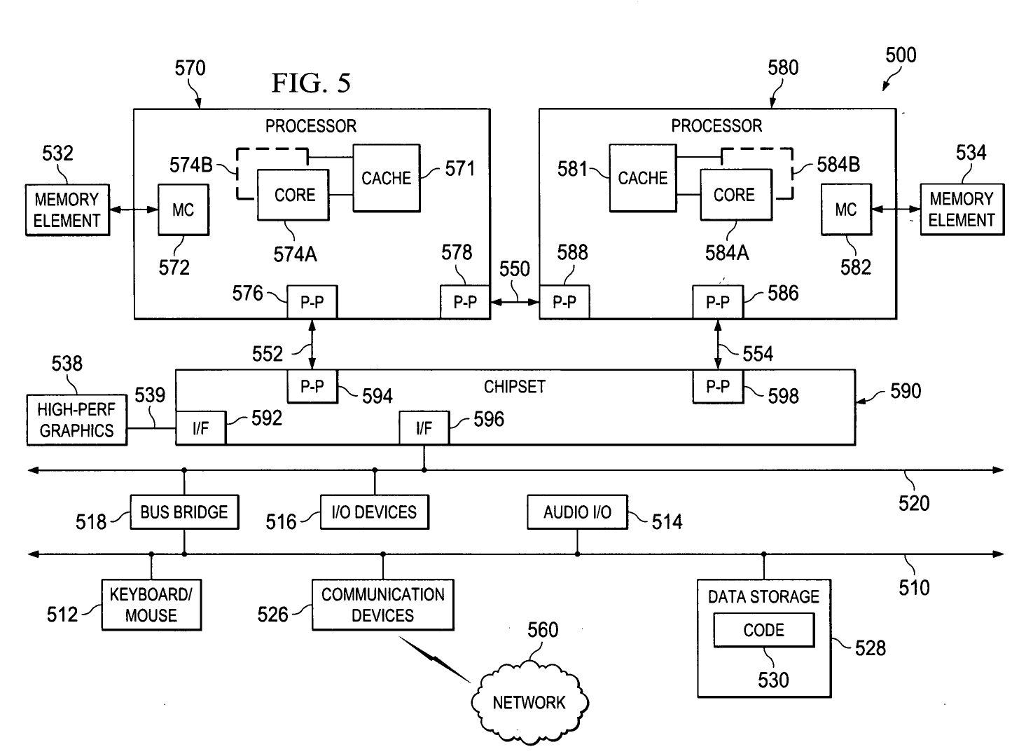

Turning to FIG. 5, FIG. 5 illustrates a computing system 500 that is arranged in a point-to-point (PtP) configuration according to an embodiment. In particular, FIG. 5 shows a system where processors, memory, and input/output devices are interconnected by a number of point-to-point interfaces. Generally, one or more of the network elements of communication system 100 may be configured in the same or similar manner as computing system 500.

As illustrated in FIG. 5, system 500 may include several processsors, of which only two, processors 570 and 580, are shown for clarity. While two processors 570 and 580 are shown, it is to be understood that an embodiment of system 500 may also include only one such processor. Processors 570 and 580 may each include a set of cores (i.e., processor cores 574A and 574B and processor cores 584A and 584B) to execute multiple threads of a program. The cores may be configured to execute instruction code in a manner similar to that discussed above with reference to FIGS. 1-4. Each processor 570, 580 may include at least one shared cache 571, 581. Shared caches 571, 581 may store data (e.g., instructions) that are utilized by one or more components of processors 570, 580, such as processor cores 574 and 584.

Processors 570 and 580 may also each include integrated memory controller logic (MC) 572 and 582 to communicate with memory elements 532 and 534. Memory elements 532 and/or 534 may store various data used by processors 570 and 580. In alternative embodiments, memory controller logic 572 and 582 may be discreet logic separate from processors 570 and 580.

Processors 570 and 580 may be any type of processor and may exchange data via a point-to-point (PtP) interface 550 using point-to-point interface circuits 578 and 588, respectively. Processors 570 and 580 may each exchange data with a chipset 590 via individual point-to-point interfaces 552 and 554 using point-to-point interface circuits 576, 586, 594, and 598. Chipset 590 may also exchange data with a high-performance graphics circuit 538 via a high-performance graphics interface 539, using an interface circuit 592, which could be a PtP interface circuit. In alternative embodiments, any or all of the PtP links illustrated in FIG. 5 could be implemented as a multi-drop bus rather than a PtP link.

Chipset 590 may be in communication with a bus 520 via an interface circuit 596. Bus 520 may have one or more devices that communicate over it, such as a bus bridge 518 and I/O devices 516. Via a bus 510, bus bridge 518 may be in communication with other devices such as a keyboard/mouse 512 (or other input devices such as a touch screen, trackball, etc.), communication devices 526 (such as modems, network interface devices, or other types of communication devices that may communicate through a computer network 560), audio I/O devices 514, and/or a data storage device 528. Data storage device 528 may store code 530, which may be executed by processors 570 and/or 580. In alternative embodiments, any portions of the bus architectures could be implemented with one or more PtP links.

The computer system depicted in FIG. 5 is a schematic illustration of an embodiment of a computing system that may be utilized to implement various embodiments discussed herein. It will be appreciated that various components of the system depicted in FIG. 5 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

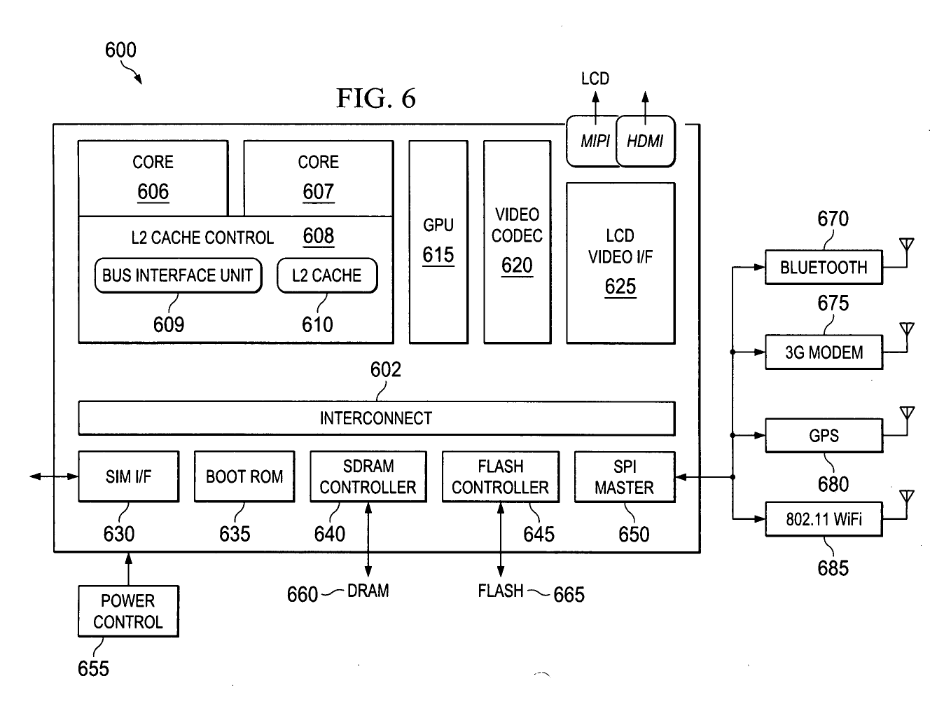

Turning to FIG. 6, FIG. 6 is a simplified block diagram associated with an example SOC 600 of the present disclosure. At least one example implementation of the present disclosure can include the protection of sensitive chat data features discussed herein. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 6, SOC 600 may include multiple cores 606-607, an L2 cache control 608, a bus interface unit 609, an L2 cache 610, a graphics processing unit (GPU) 615, an interconnect 602, a video codec 620, and a liquid crystal display (LCD) I/F 625, which may be associated with mobile industry processor interface (MIPI)/high-definition multimedia interface (HDMI) links that couple to an LCD.

SOC 600 may also include a subscriber identity module (SIM) I/F 630, a boot read-only memory (ROM) 635, a synchronous dynamic random access memory (SDRAM) controller 640, a flash controller 645, a serial peripheral interface (SPI) master 650, a suitable power control 655, a dynamic RAM (DRAM) 660, and flash 665. In addition, one or more example embodiments include one or more communication capabilities, interfaces, and features such as instances of Bluetooth™ 670, a 3G modem 675, a global positioning system (GPS) 680, and an 802.11 Wi-Fi 685.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

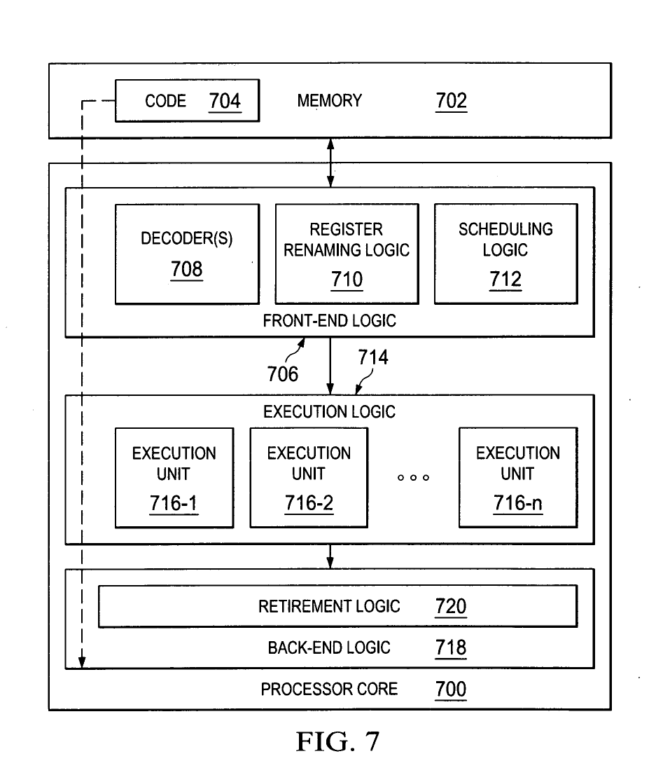

Turning to FIG. 7, FIG. 7 illustrates a processor core 700 according to an embodiment. Processor core 700 may be the core for any type of processor, such as a micro-processor, an embedded processor, a digital signal processor (DSP), a network processor, or other device to execute code. Although only one processor core 700 is illustrated in FIG. 7, a processor may alternatively include more than one of the processor core 700 illustrated in FIG. 7. For example, processor core 700 represents one example embodiment of processors cores 574a, 574b, 574a, and 574b shown and described with reference to processors 570 and 580 of FIG. 5. Processor core 700 may be a single-threaded core or, for at least one embodiment, processor core 700 may be multithreaded in that it may include more than one hardware thread context (or “logical processor”) per core.

FIG. 7 also illustrates a memory 702 coupled to processor core 700 in accordance with an embodiment. Memory 702 may be any of a wide variety of memories (including various layers of memory hierarchy) as are known or otherwise available to those of skill in the art. Memory 702 may include code 704, which may be one or more instructions, to be executed by processor core 700. Processor core 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor core 700 can also include execution logic 714 having a set of execution units 716-1 through 716-N. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor core 700 allows out of order execution but requires in order retirement of instructions. Retirement logic 720 may take a variety of known forms (e.g., re-order buffers or the like). In this manner, processor core 700 is transformed during execution of code 704, at least in terms of the output generated by the decoder, hardware registers and tables utilized by register renaming logic 710, and any registers (not shown) modified by execution logic 714.

Although not illustrated in FIG. 7, a processor may include other elements on a chip with processor core 700, at least some of which were shown and described herein with reference to FIG. 5. For example, as shown in FIG. 5, a processor may include memory control logic along with processor core 700. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and their teachings are readily scalable and can accommodate a large number of components, as well as more complicated/sophisticated arrangements and configurations. Accordingly, the examples provided should not limit the scope or inhibit the broad teachings of communication system 100 and as potentially applied to a myriad of other architectures.

It is also important to note that the operations in the preceding flow diagrams (i.e., FIG. 4) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable medium having one or more instructions that when executed by at least one processor cause the at least one processor to receive a message, determine that at least a portion of the message includes sensitive data, obfuscate the portion of the message that includes sensitive data, and communicate the message to an electronic device, where the obfuscated portion of the message can be recognized and understood by a recipient associated with the electronic device.

In Example C2, the subject matter of Example C1 can optionally include where the the obfuscated portion of the message cannot be readily analyzed by a text parsing bot.

In Example C3, the subject matter of any one of Examples C1-C2 can optionally include where the obfuscated portion includes a human intelligence task element.

In Example C4, the subject matter of any one of Examples C1-C3 can optionally include where the message is a combination of HTML elements and scripts.

In Example C5, the subject matter of any one of Examples C1-C4 can optionally include where the message is a combination of HTML elements, scripts, and human intelligence task elements.

In Example C6, the subject matter of any one of Examples C1-C5 can optionally include where the sensitive data is identified by a sensitive content detection engine.

In Example A1, an apparatus can include a security engine, where the security engine is configured to receive a message, determine that at least a portion of the message includes sensitive data, obfuscate the portion of the message that includes sensitive data, and communicate the message to an electronic device, where the obfuscated portion of the message can be recognized and understood by a recipient associated with the electronic device.

In Example, A2, the subject matter of Example A1 can optionally include where the obfuscated portion of the message cannot be readily analyzed by a text parsing bot.

In Example A3, the subject matter of any one of Examples A1-A2 can optionally include where the obfuscated portion includes a human intelligence task element.

In Example A4, the subject matter of any one of Examples A1-A3 can optionally include where the message is a combination of HTML elements and scripts.

In Example A5, the subject matter of any one of Examples A1-A4 can optionally include where the message is a combination of HTML elements, scripts, and human intelligence task elements.

Example M1 is a method including receiving a message, determining that at least a portion of the message includes sensitive data, obfuscating the portion of the message that includes sensitive data, and communicating the message to an electronic device, where the obfuscated portion of the message can be recognized and understood by a recipient associated with the electronic device.

In Example M2, the subject matter of Example M1 can optionally include where the obfuscated portion of the message cannot be readily analyzed by a text parsing bot.

In Example M3, the subject matter of any one of the Examples M1-M2 can optionally include where the obfuscated portion includes a human intelligence task element.

In Example M4, the subject matter of any one of the Examples M1-M3 can optionally include where the message is a combination of HTML elements and scripts.

In Example M5, the subject matter of any one of the Examples M1-M4 can optionally include where the message is a combination of HTML elements, scripts, and human intelligence task elements.

Example S1 is a system for mitigating bot scans of communications, the system including a security engine, where the security engine is configured to receive a message, determine that at least a portion of the message includes sensitive data, obfuscate the portion of the message that includes sensitive data, and communicate the message to an electronic device, where the obfuscated portion of the message can be recognized and understood by a recipient associated with the electronic device.

In Example S2, the subject matter of Example S1 can optionally include where the obfuscated portion of the message cannot be readily analyzed by a text parsing bot.

In Example S3, the subject matter of any of the Examples S1-S2 can optionally include where the obfuscated portion includes a human intelligence task element.

Example X1 is a machine-readable storage medium including machine-readable instructions to implement a method or realize an apparatus as in any one of the Examples A1-A5, or M1-M5. Example Y1 is an apparatus comprising means for performing of any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

1. At least one non-transitory machine readable medium comprising one or more instructions that when executed by at least one processor, cause the at least one processor to:
receive a message;
determine that at least a portion of the message includes sensitive data;
obfuscate the portion of the message that includes sensitive data, wherein the obfuscation is a representation of the sensitive data, and wherein the obfuscation comprises one of more of a script, a human intelligence task element, an image, and a hypertext markup language element; and
communicate the message with the obfuscated portion to an electronic device, wherein the obfuscated portion of the message can be recognized and understood by a recipient associated with the electronic device.

2. The at least one non-transitory machine readable medium of claim 1, wherein the obfuscated portion of the message cannot be readily analyzed by a text parsing bot.

3. The at least one non-transitory machine readable medium of claim 1, wherein the obfuscated portion includes a human intelligence task element.

4. The at least one non-transitory machine readable medium of claim 1, wherein the message is a combination of hypertext markup language (HTML) elements and scripts.

5. The at least one non-transitory machine readable medium of claim 1, wherein the message is a combination of hypertext markup language (HTML) elements, scripts, and human intelligence task elements.

6. (canceled)

7. An apparatus comprising:
hardware processor configured to:
receive a message;
determine that at least a portion of the message includes sensitive data;
obfuscate the portion of the message that includes sensitive data, wherein the obfuscation is a representation of the sensitive data, and wherein the obfuscation comprises one of more of a script, a human intelligence task element, an image, and a hypertext markup language element; and
communicate the message with the obfuscated portion to an electronic device, wherein the obfuscated portion of the message can be recognized and understood by a recipient associated with the electronic device.

8. The apparatus of claim 7, wherein the obfuscated portion of the message cannot be readily analyzed by a text parsing bot.

9. The apparatus of claim 7, wherein the obfuscated portion includes a human intelligence task element.

10. The apparatus of claim 7, wherein the message is a combination of hypertext markup language (HTML) elements and scripts.

11. The apparatus of claim 7, wherein the message is a combination of hypertext markup language (HTML) elements, scripts, and human intelligence task elements.

12. (canceled)

13. A method comprising:
receiving a message;
determining that at least a portion of the message includes sensitive data;
obfuscating the portion of the message that includes sensitive data wherein the obfuscation is a representation of the sensitive data, and wherein the obfuscation comprises one of more of a script, a human intelligence task element, an image, and a hypertext markup language element; and
communicating the message with the obfuscated portion to an electronic device, wherein the obfuscated portion of the message can be recognized and understood by a recipient associated with the electronic device.

14. The method of claim 13, wherein the obfuscated portion of the message cannot be readily analyzed by a text parsing bot.

15. The method of claim 13, wherein the obfuscated portion includes a human intelligence task element.

16. The method of claim 13, wherein the message is a combination of hypertext markup language (HTML) elements and scripts.

17. The method of claim 13, wherein the message is a combination of hypertext markup language (HTML) elements, scripts, and human intelligence task elements.

18. A system for mitigating bot scans of communications, the system comprising:
hardware processor configured to:
receive a message;
determine that at least a portion of the message includes sensitive data;
obfuscate the portion of the message that includes sensitive data wherein the obfuscation is a representation of the sensitive data, and wherein the obfuscation comprises one of more of a script, a human intelligence task element, an image, and a hypertext markup language element; and
communicate the message with the obfuscated portion to an electronic device, wherein the obfuscated portion of the message can be recognized and understood by a recipient associated with the electronic device.

19. The system of claim 18, wherein the obfuscated portion of the message cannot be readily analyzed by a text parsing bot.

20. The system of claim 18, wherein the obfuscated portion includes a human intelligence task element.
